(19) United States
(12) Patent Application Publication
(10) Pub. No.: US 2005/0139581 A1
(43) Pub. Date: Jun. 30, 2005

(54) High-strength superalloy joining method for repairing turbine blades

(76) Inventor: Yiping Hu, Greer, SC (US)

Correspondence Address: HONEYWELL INTERNATIONAL INC., 101 COLUMBIA ROAD, P O BOX 2245, MORRISTOWN, NJ, 07962-2245, US

(21) Appl. No.: 10/746,388

(22) Filed: Dec. 24, 2003

(51) Int. Cl. B23K 15/00; B23K 26/34; B23K 26/24

(52) U.S. Cl. 219/121.14; 219/121.64

(57) ABSTRACT

A method of repairing high-strength superalloy turbine blades and joining superalloy components is provided. A damaged region of the turbine blade is welded without preheating it. The welded turbine blade is then subjected to a hot isostatic pressing process. The method results in a repaired turbine blade that has a desirable microstructure and robust mechanical properties.

### FIELD OF THE INVENTION

The present invention relates to a method of joining high-strength superalloy components and, more particularly, to a method of repairing high-strength superalloy turbine blades.

### BACKGROUND OF THE INVENTION

A gas turbine engine may be used to power various types of systems and vehicles. Various types of gas turbine engines are used to provide this power. Such gas turbine engines include, for example, industrial gas turbine engines and turbofan gas turbine engines. Industrial gas turbine engines may be used, for example, to power a large electrical generator, which in turn produces electrical power for various loads. Turbofan gas turbine engines may be used, for example, to power an aircraft.

A gas turbine engine, whether it is an industrial gas turbine engine or a turbofan gas turbine engine, includes at least a compressor section, a combustor section, and a turbine section. The compressor section raises the pressure of the air it receives to a relatively high level. The compressed air from the compressor section then enters the combustor section, where a plurality of fuel nozzles injects a steady stream of fuel. The injected fuel is ignited by a burner, which significantly increases the energy of the compressed air.

The high-energy compressed air from the combustor section then flows into and through the turbine section, causing rotationally mounted turbine blades to rotate and generate energy. Specifically, high-energy compressed air impinges on nozzle guide vanes and turbine blades, causing the turbine to rotate.

Gas turbine engines typically operate more efficiently with increasingly hotter air temperature. The materials used to fabricate the components of the turbine, such as the nozzle guide vanes and turbine blades, typically limit the maximum air temperature. In current gas turbine engines, the turbine blades are made of advanced nickel-based superalloys such as, for example, IN738, IN792, MarM247, GTD-111, Rene142, and CMSX4, etc. These materials exhibit good high-temperature strength; however, the high temperature environment within a turbine can cause, among other things, corrosion, oxidation, erosion, and/or thermal fatigue of the turbine blades and nozzles made of these materials.

Replacing turbine components made with the above-noted superalloys can be both difficult and costly to manufacture. Thus, it is more desirable to be able to repair a worn or damaged turbine blade than it is to replace one. As a result, a variety of repair methods have been developed, including various traditional weld repair processes. For example, many turbine blades are repaired using conventional TIG (tungsten inert gas) or laser welding process, with a superalloy filler material, such as IN-625, IN-738, and MarM247, etc.

Unfortunately, traditional weld repair processes, such as those mentioned above, have met with only limited success. There are various reasons for this. Included among the reasons, is that the material properties of the IN-625 alloy filler may not be as robust as the material properties of the turbine blades. Moreover, the advanced superalloy fillers used to repair the turbine blades easily form cracks during a weld repair. Furthermore, stress rupture strength of the welded buildup is quite low due to a small grain size. Because of these, and other drawbacks, it is difficult to repair a high-stress area airfoil of a turbine blade, and turbine blades are many times scrapped rather than repaired. This can lead to increased costs over the life of a turbine.

Hence, there is a need for a method of joining various parts made of superalloys, such as superalloy turbine blades and nozzle guide vanes, which results in a sound weld during and following the repair process, and/or that reduces the likelihood of scrapping damaged turbine blades, and/or reduces lifetime turbine costs. The present invention addresses one or more of these needs.

### SUMMARY OF THE INVENTION

The present invention provides a method of repairing high-strength superalloy turbine blades. In one embodiment, and by way of example only, a method of repairing a damaged region on a gas turbine engine turbine blade that is constructed at least partially of a superalloy includes welding the damaged region of the turbine blade without preheating the damaged region, whereby a weld seam having a surface is formed. The welded turbine blade is then subjected to a hot isostatic pressing (HIP) process.

In another exemplary embodiment, a method of joining components that are constructed at least partially of a superalloy includes welding the components together without preheating the components, whereby a joined component is formed. The joined component is subject to a hot isostatic pressing process.

Other independent features and advantages of the preferred repair method will become apparent from the following detailed description, taken in conjunction with the accompanying drawings which illustrate, by way of example, the principles of the invention.

### BRIEF DESCRIPTION OF THE DRAWINGS

FIG. 1 is a cross section side view of a portion of an exemplary industrial gas turbine engine;

FIG. 2 is a perspective view of an exemplary turbine blade that may be used in the industrial gas turbine engine of FIG. 1; and

FIG. 3 is a simplified perspective view of two superalloy substrates, which may be the turbine blades of FIG. 2, undergoing a welding process in accordance with an embodiment of the present invention.

### DETAILED DESCRIPTION OF A PREFERRED EMBODIMENT

Before proceeding with a detailed description, it is to be appreciated that the described embodiment is not limited to use in conjunction with a particular type of turbine engine, or even to use in a turbine. Thus, although the present embodiment is, for convenience of explanation, depicted and described as being used to repair the turbine blades and nozzles in an industrial gas turbine jet engine, it will be appreciated that it can be used to repair blades and nozzles in various other types of turbines, as well as to join and/or repair various other components formed of superalloys that may be implemented in various other systems and environments.

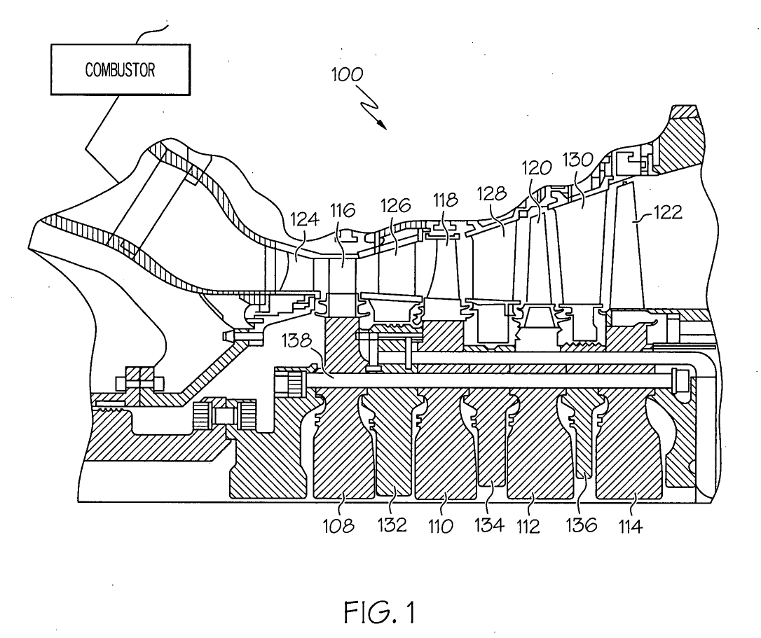

A cross section of an exemplary embodiment of a portion of an industrial gas turbine engine 100 is depicted in FIG. 1. As is generally known, industrial gas turbine engines, such as the one shown in FIG. 1, include at least a compressor section, a combustion section, and a turbine section. For clarity and ease of explanation, FIG. 1 depicts only a combustion section 102 and a turbine section 104.

The combustion section 102, which includes a plurality of non-illustrated combustors, receives high pressure air from a non-illustrated compressor. The high pressure air is mixed with fuel, and is combusted, producing high-energy combusted air. The combusted air is then directed into the turbine section 104, via a gas flow passage 105.

The turbine section 104 includes a rotor 106 having a plurality of turbine wheels 108, 110, 112, 114 mounted thereon. A plurality of turbine blades 116, 118, 120, 122 are mounted on each turbine wheel 108, 110, 112, 114, and extend radially outwardly into the gas flow passage 105. The turbine blades 116, 118, 120, 122 are arranged alternately between fixed nozzles 124, 126, 128, 130. Moreover, a plurality of spacers 132, 134, 136, are alternately disposed between the turbine wheels 108, 110, 112, 114, and are located radially inwardly of a respective one of the nozzles 124, 126, 128, 130. In the depicted embodiment, the turbine wheels 108, 110, 112, 114 and spacers 132, 134, 136 are coupled together via a plurality of circumferentially spaced, axially extending fasteners 138 (only one shown).

The combusted air supplied from the combustion section 102 expands through the turbine blades 116, 118, 120, 122 and nozzles 124, 126, 128, 130, causing the turbine wheels 108, 110, 112, 114 to rotate. The rotating turbine wheels 108, 110, 112, 114 drive equipment such as, for example, an electrical generator, via a non-illustrated shaft.

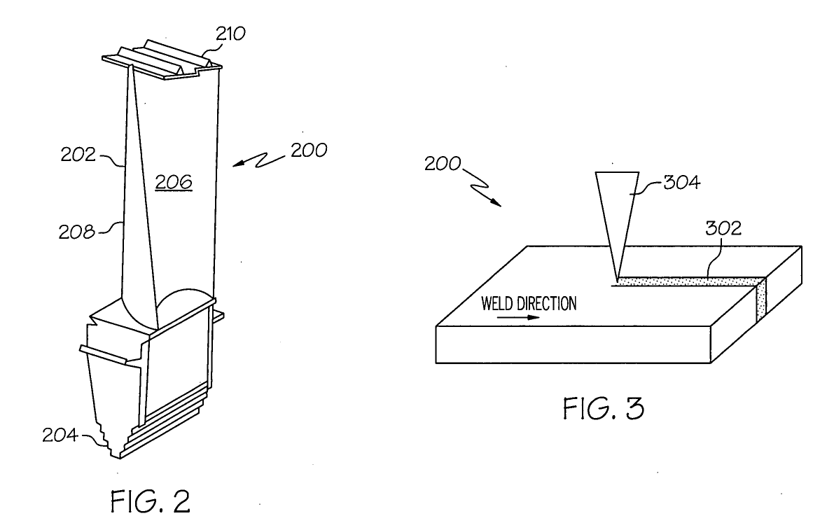

Turning now to FIG. 2, a perspective view of an exemplary turbine blade that may be used in the industrial gas turbine engine of FIG. 1 is shown. The turbine blade 200, which is formed of a nickel-base superalloy, includes an airfoil 202 (or “bucket”) and a mounting section 204. The bucket 202 is coupled to the mounting section 204, which is in turn mounted to a turbine wheel (not shown). The bucket 202 includes an upstream side 206, against which the combusted air exiting the combustor section 102 impinges, and a downstream side 208. In the depicted embodiment, the turbine blade 200 additionally includes a shroud 210 coupled to the end of the bucket 202.

The turbine blades 200 and nozzles in a turbine, such as the industrial gas turbine 100 described above, may become worn or otherwise damaged during use. In particular, as was previously noted, the turbine blades and nozzles may undergo corrosion, oxidation, erosion, and/or thermal fatigue during use. Thus, as was alluded to previously, a reliable method of repairing a worn or damaged turbine blade is needed. In accordance with a particular preferred embodiment, a method of repairing a worn or damaged superalloy turbine blade 200 includes subjecting the worn or damaged turbine blade 200 to a welding process, without first preheating the blade 200. The weld seam formed by the welding process may then inspected to determine whether any cracks have formed in the weld seam surface, and if so, the cracks are sealed. Thereafter, the turbine blade 200 is subjected to a hot isostatic pressing (HIP) process. This general process will now be described in more detail.

When one or more worn or damaged turbine blades 200 are identified during, for example, routine turbine maintenance, repair, or inspection, the worn or damaged turbine blades 200 are removed from the turbine. The turbine blades 200, or at least the worn or damaged section(s) of the blades 200, are prepared for repair. This preparation includes, for example, degreasing the blades 200, stripping a coating off of the surface of the blades 200, removing oxidation from the blades 200, and degreasing the blades, if necessary, once again. It will be appreciated that the present embodiment is not limited to these preparatory steps, and that additional, or different types and numbers of preparatory steps can be conducted. It will additionally be appreciated that these preparatory steps may be conducted using either, or both, chemical and mechanical types of processes.

Once the turbine blade 200 has been prepared, it is then subjected to a welding process to join a superalloy material to the worn or damaged area. The material joined to the worn or damaged area may be identical to the base material of the turbine blade 200, or at least have mechanical properties that substantially match those of the base metal. The welding process, which is depicted in simplified schematic form in FIG. 3, may be either an electron beam (EB) welding process, or a laser welding process, and is conducted without first preheating the turbine blade 200. As is generally known, EB welding produces a weld seam 302 on a workpiece, such as a turbine blade 200, by impinging a high-energy electron beam 304 on the workpiece, whereas laser welding produces the weld seam 302 by impinging a high-energy laser beam 304 on the workpiece. The laser beam 304 is preferably produced using a CO₂ laser, a YAG laser, a diode laser, or a fiber laser, though it will be appreciated that other laser types could also be used. It is additionally noted that preferably no filler material is used during this welding process, though it will be appreciated that a filler material could be used.

No matter the particular type of welding process used, either EB welding or laser welding, once the weld process is complete, the weld seam 302 may be inspected to determine whether any surface defects, such as cracks or pores, exist. This inspection process can be conducted using any one of numerous known non-destructive inspection techniques including, but not limited to, fluorescent penetration inspection, or a radiographic inspection.

If the inspection process indicates that surface defects exist in the weld seam 302, the turbine blade 200 is subjected to an additional process to seal the seam surface. This additional process may be either another laser welding process or a liquid-phase diffusion bond process. If the laser welding process is used it is preferably a laser powder fusion welding process. As is generally known, during a laser powder fusion welding process, a powder filler material, such as IN-625, is supplied to the weld zone to seal surface defects on the weld seam. As is also generally known, a liquid-phase diffusion bond process is based on the diffusion of atoms through the crystal lattice of a crystalline solid. In a typical liquid-phase diffusion bond process, such as the Honeywell® JetFix® process, a filler material, that is a mixture of a high melting-temperature constituent, a low melting-temperature constituent, and a binder, is applied to the weld seam 302, and the turbine blade 200 is then diffusion heat treated. The filler material heals the surface defects in the weld seam 302, via capillary action, during the heat treatment process.

Before proceeding with the remaining description of the repair methodology, a brief note regarding the post-EB or post-laser welding weld seam will be provided. In particular, it is generally known that when superalloy materials are subjected to either of these welding processes, that it is highly likely the weld seam will include surface defects. Thus, the weld seam inspection could be skipped, if so desired, and the process of sealing the weld seam surface, using either the laser welding process or diffusion process described above, could be conducted.

Returning now to a discussion of the repair method, after the weld seam surface is sealed, the turbine blade 200 is then subject to a hot isostatic pressing (HIP) process. As is generally known, the HIP process is a high-pressure and high temperature heat treatment. The basic HIP process includes a combination of elevated temperature and isostatic gas pressure (usually using an inert gas such as Argon) applied to a workpiece. The HIP process is usually carried out in a pressure vessel at a relatively high temperature. During the HIP process, voids, cracks, and/or defects that may exist in the turbine blade weld can be healed. Healing the voids, cracks, and/or defects substantially eliminates potential crack initiation sites Thus, the HIP process, among other things, aids in crack prevention during subsequent processing of the turbine blade 200, and upon returning the turbine blade 200 to service. The HIP process also contributes to rejuvenation of the turbine blade base metal microstructure, which can degrade after prolonged service. It will be appreciated that the pressure, temperature, and time associated with the HIP process may vary. However, in a particular preferred embodiment, the HIP process is carried out at about 2200° F. and about 15 ksi, for about 2-4 hours.

Upon completion of the HIP process, the turbine blade 200 may then be prepared for return to service, by undergoing a finishing process. The finishing process may include subjecting the turbine blade 200 to a final machining, and/or recoating process, as necessary. The finishing process may additionally include both coating and an aging heat treatment, as well as a final inspection.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method of repairing a damaged region on a gas turbine engine turbine blade that is constructed at least partially of a superalloy, comprising the steps of:
welding the damaged region of the turbine blade without preheating the damaged region, whereby a weld seam having a surface is formed; and
subjecting the welded turbine blade to a hot isostatic pressing process.

2. The method of claim 1, further comprising the step of:
sealing the weld seam surface before subjecting the welded turbine blade to the hot isostatic pressing process.

3. The method of claim 2, wherein the step of sealing the weld seam comprises:
subjecting the turbine blade to a diffusion bonding process.

4. The method of claim 2, wherein the step of sealing the weld seam comprises:
subjecting the turbine blade to a laser welding process.

5. The method of claim 4, wherein the laser welding process is a laser coating process.

6. The method of claim 1, wherein the welding step comprises an electron beam welding process.

7. The method of claim 1, wherein the welding step comprises a laser welding process.

8. The method of claim 7, wherein the laser welding process uses a laser that is selected from the group consisting of a CO₂ laser, a YAG laser, a diode laser, or a fiber laser.

9. The method of claim 1, wherein the hot isostatic pressing process is carried out at about 2200° F. and about 15 ksi, for about 2-4 hours.

10. A method of joining components that are constructed at least partially of a superalloy, comprising the steps of:
welding the components together without preheating the components, whereby a joined component is formed, the joined component having a weld seam that includes a surface; and
subjecting the joined component to a hot isostatic pressing process.

11. The method of claim 10, further comprising the step of:
sealing the weld seam surface before subjecting the joined components to the hot isostatic pressing process.

12. The method of claim 11, wherein the step of sealing the weld seam surface comprises:
subjecting the weld seam to a diffusion bonding process.

13. The method of claim 11, wherein the step of sealing the weld seam surface comprises:
subjecting the weld seam to a laser welding process.

14. The method of claim 13, wherein the laser welding process is a laser coating process.

15. The method of claim 10, wherein the welding step comprises an electron beam welding process.

16. The method of claim 10, wherein the welding step comprises a laser welding process.

17. The method of claim 16, wherein the laser welding process uses a laser that is selected from the group consisting of a CO₂ laser, a YAG laser, a diode laser, or a fiber laser.

18. The method of claim 10, wherein the hot isostatic pressing process is carried out at about 2200° F. and about 15 ksi, for about 2-4 hours.

19. A method of repairing a damaged region on a gas turbine engine turbine blade that is constructed at least partially of a superalloy, comprising the steps of:
welding the damaged region of the turbine blade without preheating the damaged region, whereby a weld seam having a surface is formed;
sealing the weld seam surface; and
subjecting the welded turbine blade to a hot isostatic pressing process.

20. The method of claim 19, wherein the step of sealing the weld seam surface comprises:
subjecting the weld seam to a diffusion bonding process.

21. The method of claim 19, wherein the step of sealing the weld seam surface comprises:
subjecting the weld seam to a laser welding process.

22. The method of claim 21, wherein the laser welding process is a laser coating process.

23. The method of claim 19, wherein the welding step compnses an electron beam welding process.

24. The method of claim 19, wherein the welding step comprises a laser welding process.

25. The method of claim 24, wherein the laser welding process uses a laser that is selected from the group consisting of a CO₂ laser, a YAG laser, a diode laser, or a fiber laser.

26. The method of claim 19, wherein the hot isostatic pressing process is carried out at about 2200° F. and about 15 ksi, for about 2-4 hours.
